(19) United States
(12) Patent Application Publication
(10) Pub. No.: US 2020/0049444 A1
(43) Pub. Date: Feb. 13, 2020

(54) Firearm Mounting Device

(71) Applicant: Charlie R. Cerda, Katy, TX (US)

(72) Inventor: Charlie R. Cerda, Katy, TX (US)

(21) Appl. No.: 16/520,161

(22) Filed: Jul. 23, 2019

Related U.S. Application Data
(60) Provisional application No. 62/701,935, filed on Jul. 23, 2018.

(51) Int. Cl. F41A 23/18; B60R 7/14

(52) U.S. Cl. CPC F41A 23/18; F16B 1/00; B60R 7/14

(57) ABSTRACT

A firearm mounting device is to carry or mount a firearm, such as a handgun, that is unloaded which allows the mounted firearm to be gripped and loaded quickly and easily while within the firearm mounting device. Preferably, the firearm mounting device comprises a magnetic base, mounting means, sidewalls, a site slot, and a firearm slide catch mechanism.

### CROSS-REFERENCE TO RELATED APPLICATIONS

This application claims priority to U.S. Provisional Application Nos. 62/701,935 (“the '935 application”) filed Jul. 23, 2018. The '935 application is hereby incorporated by reference in its entirety for all purposes, including but not limited to, all portions describing the present invention and the embodiments disclosed, those portions describing in general the background and uses for specific embodiments of the present invention, and those portions describing other aspects of manufacturing and testing of the present invention.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

### 1. Field of the Invention

The present invention relates to a mounting device for firearms. More particularly, the present invention relates to a device for mounting a firearm that assists with loading the firearm.

### 2. Description of the Related Art

Storage of firearms in a manner that allows for easy accessibility for use in an emergency situation is a problem. Many individuals find that they would like to have access to their firearm, for example when in a vehicle, but there are only a few options of where to store the firearm. In vehicles, an individual may store the firearm in the glove compartment, but such location is not very convenient if the individual wants to retrieve the firearm quickly, i.e., it is not within easy reach. Other locations include laying the firearm on/under or around the seating areas. Such locations are also inadequate as the firearm is either easily dislodged in the case of quick acceleration/deceleration (i.e., accidents), or it are not within easy reach of the individual. Thus, there is a need for a vehicle mount that will permit a person to safely and securely mount their weapon, while also keeping it within a convenient reach. An example of one such device that has attempted to address this issue is disclosed in U.S. Pat. No. 9,010,600 to Gleaton et al. As best can be determined, Gleason discloses a holster comprising a tension strap that can be mounted within a vehicle interior to securely hold a handgun. Problems with this type of device include difficulties in quickly removing the handgun for use in an emergency. Further, after removing the handgun from the holster, the user then needs to load a round into the handgun's chamber which requires additional time.

Similarly, it would be desirable to mount a handgun for storage of firearms in homes or other buildings that allows for easy accessibility of use during an emergency. While there are any number of means of storing firearms indoors such as gun safes, gun racks, and even personal holsters, it can be difficult to access and retrieve the firearm quickly when a potential emergency is anticipated. Further, even after retrieving the firearm from these other storage areas, there remains a need to load a round in the chamber before the firearm can be used.

Thus, as can now be seen, it would be desirable to mount an unloaded firearm in vehicle or otherwise in a manner that the firearm can be quickly and easily retrieved and loaded for use in an emergency situation.

### BRIEF SUMMARY OF THE INVENTION

The present invention is firearm mounting device. Preferably, the firearm mounting device is designed to carry or mount a firearm, such as a handgun, that is unloaded while allowing the mounted firearm to be gripped and loaded quickly and easily while within the firearm mounting device. In a particular embodiment the device comprises a base having a magnetic portion for magnetically attracting a firearm, preferably the magnetic portion being near the center, and mounting means such as attachment holes, preferably around the outside of the base. Preferably, this embodiment includes a slot interior near a bottom edge of the base for accepting a front site from a firearm while the firearm is contacting the magnetic portion of the base. Preferably, two side walls protrude outwardly from base, preferably from opposite sides of the magnetic portion of the base. Preferably, the sidewalls flare outwardly to act as guides for mounting the firearm in place. Preferably, the embodiment further comprises a slide catch means for catching the firearm slide and keeping it stationary while allowing the firearm's barrel to be push through thereby loading a round into the firearm chamber. Preferably, the slide catch comprises protrusions projecting outwardly from the base positioned on opposite sides of the site slot at the bottom edge of the base.

Additional advantages of the invention are set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

A better understanding of the present invention can be obtained when the following detailed description of the disclosed embodiments is considered in conjunction with the following drawings in which:

FIG. 1 is a front view of an embodiment of a firearm mounting device made in accord with the present invention;

FIG. 2 is a side view of an embodiment of a firearm mounting device made in accord with the present invention;

FIG. 3 is a downward view of an embodiment of a firearm mounting device made in accord with the present invention;

FIG. 4 is a perspective view of an embodiment of a firearm mounting device made in accord with the present invention;

FIG. 5 is an embodiment of a firearm mounting device made in accord with the present invention in use mounting a handgun;

FIG. 6 is an embodiment of a firearm mounting device made in accord with the present invention in use loading a round into the chamber of a handgun;

FIG. 7 is a perspective view of a second embodiment of a firearm mounting device made in accordance with the present invention.

### DETAILED DESCRIPTION OF THE INVENTION

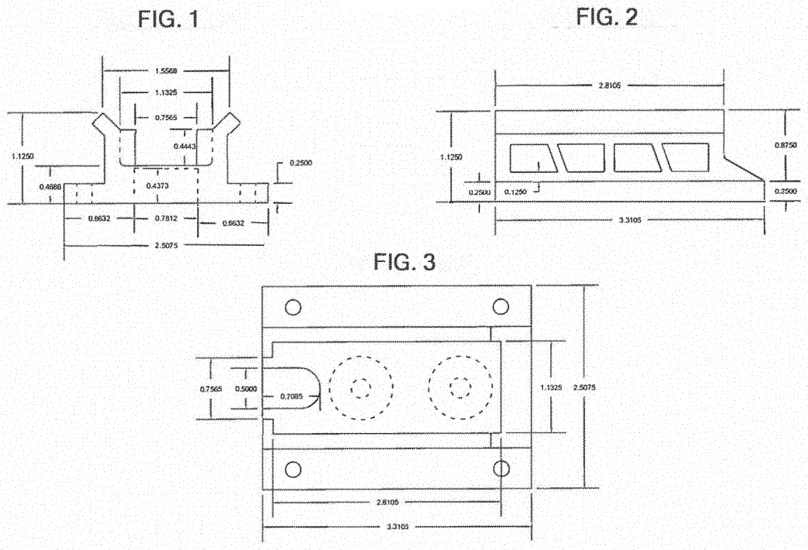

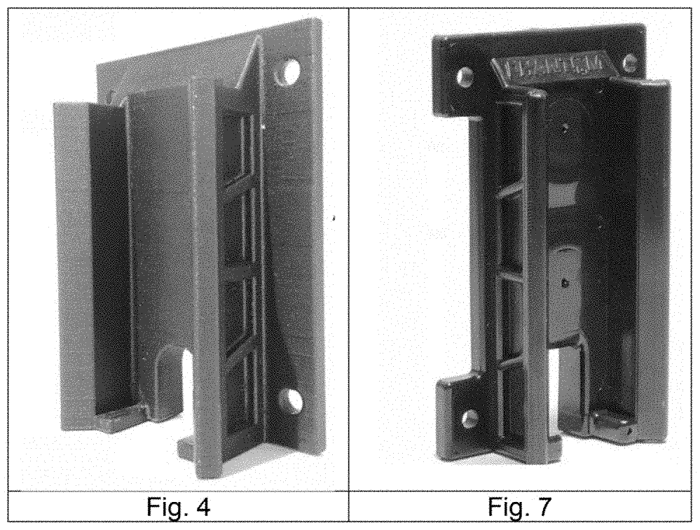

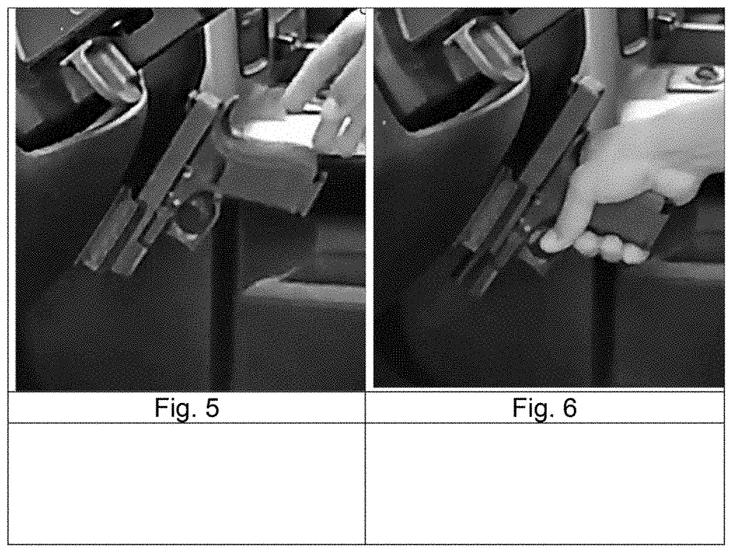

The present invention is firearm mounting device. Preferably, the firearm mounting device is designed to carry or mount a firearm, such as a handgun, that is unloaded while allowing the mounted firearm to be gripped and loaded quickly and easily while within the firearm mounting device. As show in FIGS. 1-7, particular embodiments of the device comprises a base having a magnetic portion for magnetically attracting a firearm, preferably the magnetic portion being near the center, and mounting means such as attachment holes, preferably around the outside of the base.

In one embodiment, the magnetic portion comprises a single magnet, but in more a more preferred embodiment, two magnets are utilized in the magnetic portion. As will be recognized by those of skill in the art, the magnet portion may utilize one or more magnets depending the size and or power of the magnets, the weight of the firearm, etc.

The mounting means preferably comprises attachment holes through which mounting screws are utilized to firmly secure the firearm mounting device. Nails may alternatively be utilized when mounting the device on a suitable structure. The mounting means must be sufficient to securely mount the firearm mounting device and hold against the downward force required to load the firearm. As will be recognized by persons of skill in the art, other means of mounting such as clips, pins, adhesives, brackets, bands, magnets, etc. whether integral to the base or otherwise.

As shown in FIGS. 1-3, an embodiment of the firearm mounting means preferably includes approximately the dimensions shown. The dimensions shown are in inches. Such an embodiment accommodates a wide variety of sizes and makes of firearms. Preferred embodiments of the base can be about 2.5×3.3 inches or about 2.5×4.0 inches. Preferably, the firearm mounting device securely holds firearms weighing up to about 44 pounds. As a person of skill in the art will now recognize, the dimensions of the firearm mounting device can be modified from the embodiment shown to accommodate specific firearms or different range of firearms.

Preferably, this embodiment includes a slot interior near a bottom edge of the base for accepting a front site from a firearm while the firearm is contacting the magnetic portion of the base.

Preferably, two side walls protrude outwardly from base, preferably from opposite sides of the magnetic portion of the base. Preferably, the sidewalls flare outwardly to act as guides for mounting the firearm in place. In preferred embodiments, the top portions of the side walls are angled to act as a guide when the firearm is being mounted. If the user is off aim by a small amount with mounting the firearm, this feature can help guide the firearm into place.

Preferably, the embodiment further comprises a slide catch means for catching the firearm slide and keeping it stationary while allowing the firearm's barrel to be push through thereby loading a round into the firearm chamber. Preferably, the slide catch comprises protrusions projecting outwardly from the base positioned on opposite sides of the site slot at the bottom edge of the base. As will now be recognized, the embodiment of the slide catch disclosed is designed to work with several different sized weapons. In another preferred embodiment, addition to the slide catch where the top of the slide meets the tip of firearm mounting device to create a bigger catch that will make the firearm mounting device even more versatile for different manufacture firearms.

Preferably, the firearm mounting device is manufactured using plastic injection molding with the imbedded magnet. This process allows the most efficiency and decreases assembly requirements. Alternatively, the firearm mounting device can be formed by using CNC machining of a solid block of plastic. The magnet portion of the firearm mounting device is then preferably added post-machining and secured via injected plastic or other methods of securing as would be recognized by a person of skill in the art.

Preferably, the firearm mounting device holds a wide range of calibers, manufacture types, and styles of handguns. As will now be recognized, the firearm mounting device dimensions can be scaled down to accommodate compact firearms. Alternatively, the slide catch may be modified to load a round into different type firearms that require different actions for loading.

While the terms used herein are believed to be well-understood by one of ordinary skill in the art, definitions are set forth to facilitate explanation of certain of the presently-disclosed subject matter.

Following long-standing patent law convention, the terms “a”, “an”, and “the” refer to one or more when used in this application, including the claims. Thus, for example, reference to “a protursion” includes a plurality of such protrusions, and so forth.

Unless otherwise indicated, all numbers expressing quantities of elements, dimensions such as width and area, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of a dimension, area, percentage, etc., is meant to encompass variations of in some embodiments plus or minus 20%, in some embodiments plus or minus 10%, in some embodiments plus or minus 5%, in some embodiments plus or minus 1%, in some embodiments plus or minus 0.5%, and in some embodiments plus or minus 0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, S, C, and/or O” includes A, S, C, and O individually, but also includes any and all combinations and sub-combinations of A, S, C, and O.

It will be apparent to those skilled in the art that various modifications and variations can be made in the present invention without departing from the scope or spirit of the invention. In particular, materials of construction, dimensions, etc. may be changed without departing from the scope of the invention. Other embodiments of the invention will be apparent to those skilled in the art from consideration of the specification and practice of the invention disclosed herein. The foregoing disclosure and description are illustrative and explanatory thereof, and various changes in the details of the illustrated apparatus and construction and method of operation may be made without departing from the spirit in scope of the invention which is described by the following claims.

We claim:

1. A firearm mounting device comprising:
a mounting base having a forward edge, an entry edge, a left edge and a right edge, said base further comprising a magnetic portion, mounting means, and a slot proximate to the forward edge for accepting a front site from a firearm;
a pair of side walls mounted to an underside of said base proximate to the left and right edges respectively, said side walls extending downwardly from the underside of the base; and
at least one slide stop, said slide stop being a downward protrusion mounted to the underside of the base, proximate to the forward edge and the slot and mounted between the side walls.

2. The firearm mounting device of claim 1 further comprising two slide stops, each stop being a downward protrusion mounted to the underside of the base, proximate to the forward edge and the slot, each slide stop being on opposite sides of the slot and mounted between the sidewalls.

3. The firearm mounting device of claim 1 wherein the slide stop comprised a generally rectangular protrusion extending generally perpendicularly to the base and to the sidewalls.

4. The firearm mounting device of claim 1 wherein the side walls extend downwardly and generally perpendicularly to the base.

5. The firearm mounting device of claim 1 wherein the side walls extend downwardly and generally angled outwardly from the base toward the right and left edges.

6. The firearm mounting device of claim 1 wherein the mounting means comprise at least one attachment hole through which a screw or nail can be inserted to affix the device to a surface.

7. The firearm mounting device of claim 1 wherein the mounting means is selected from the group of attachment holes, clips, pins, adhesive, brackets, bands, or magnets.

8. The firearm mounting device of claim 1 wherein the side walls comprise an upper portion that flares outwardly to assist guiding the firearm into the mounting device.

9. The firearm mounting device of claim 1 wherein the magnetic portion of the base comprises a single magnet proximate to the center of the base.

10. The firearm mounting device of claim 1 wherein the magnetic portion of the base comprises more than one magnet.

11. The firearm mounting device of claim 1 wherein the base, sidewalls, and slide stop are formed integrally from molded plastic.

12. The firearm mounting device of claim 1 wherein a center portion of the base between the sidewalls has a thickness greater than the edge portions of the base.

13. A firearm mounting device comprising:
a mounting base having a forward edge, an entry edge, a left edge and a right edge, said base further comprising a magnetic portion, attachment holes, and a slot proximate to the forward edge for accepting a front site from a firearm;
a pair of side walls mounted to an underside of said base proximate to the left and right edges respectively, said side walls extending downwardly from the underside of the base; and
at a pair of slide stops, said slide stops being a generally rectangular downward protrusion mounted to the underside of the base, proximate to the forward edge and the slot, said stops being between the side walls and the slot.
